(19) United States
(12) Patent Application Publication
(10) Pub. No.: US 2019/0171985 A1
(43) Pub. Date: Jun. 6, 2019

(54) DATA ASSIGNMENT TO IDENTIFIER CODES

(71) Applicant: Promontory Financial Group LLC, Washington, DC (US)

(72) Inventor: Daniel J. Ferranti, Washington, DC (US)

(21) Appl. No.: 15/831,505

(22) Filed: Dec. 5, 2017

(51) Int. Cl. G06Q 10/06; G06F 17/30

(52) U.S. Cl. CPC G06Q 10/0635; G06Q 40/00; G06F 17/3053; G06F 17/30241

(57) ABSTRACT

A method, in a data processing system comprising a processor and a memory, for assigning data to coded entities, the method comprising receiving one or more identifier codes from a client device, wherein the one or more identifier codes correspond to branch facilities, identifying data features associated with the one or more identifier codes by accessing a registry, retrieving risk data for the data features, determining a risk rating for each of the one or more identifier codes based on the risk data for the data features, and generating risk rating data based on the determined risk rating for each of the one or more identifier codes.

### BACKGROUND

The present invention generally relates to compliance monitoring systems, and in particular, to a system for identifying geographic risk associated with anti-money laundering (AML) data features and detection of money laundering compliance risks.

Institutions may desire to increase their global profile by offering their products and services to newer countries, however, the level of compliance to AML regulations by these countries is unknown. Monitoring and detecting any suspicious financial activities has become an important aspect of conducting business in foreign countries especially given the use of financial systems by criminals, terrorist groups and other dishonest individuals to finance and support their activities. Governments have guidelines and regulations to identify such illicit use of the financial systems. In particular, banks are prone to AML regulations since money can be wired through these institutions and the inherent risk of violating AML regulations depends on the location of local branches.

### SUMMARY

A method, computing system, and computer program product for assigning data to coded entities are disclosed. According to one embodiment, said method is in a data processing system comprising a processor and a memory. Said method comprises receiving, by said data processing system, one or more identifier codes from a client device, wherein said one or more identifier codes correspond to branch facilities. Data features associated with said one or more identifier codes are identified by said data processing system. Risk data for said data features is retrieved by said data processing system. A risk rating for each of said one or more identifier codes is determined by said data processing system based on said risk data for said data features. Said method further comprises generating, by said data processing system, risk rating data based on said determined risk rating for each of said one or more identifier codes.

Said one or more identifier codes may be bank identification codes. Said data features may include at least one of a country, state, city, province, district, and county. In one embodiment, said data processing system retrieving said rating further comprises calculating geographic and anti-money laundering risk ratings for a plurality of countries, and identify said risk data for said data features from said calculated geographic and anti-money laundering risk ratings. In another embodiment, determining said risk rating for each of said one or more identifier codes further comprises determining, by said data processing system, said risk rating for each of said one or more identifier codes based on a nature of transactions occurring in said branch facilities. In yet another embodiment, generating said risk rating data further comprises generating, by said data processing system, a heat map based on said risk rating for each of said one or more identifier codes. Said heat map may comprise a graphical representation that includes a plurality of colors corresponding to risk rating values. Said heat map may further comprise a geographical map including an overlay including said plurality of colors over locations associated with said one or more identifier codes based on said risk rating for each of said one or more identifier codes.

According to one embodiment, the computing system comprises a computer processor and a computer memory operatively coupled to said computer processor. Said computer memory having disposed within it computer program instructions that, when executed by said processor, cause said computing system to carry out the step of receiving one or more identifier codes from a client device, wherein said one or more identifier codes correspond to branch facilities. Said processor identifies data features associated with said one or more identifier codes. Said processor retrieves risk data for said data features. Said processor determines a risk rating for each of said one or more identifier codes based on said risk data for said data features. Said processor further generates risk rating data based on said determined risk rating for each of said one or more identifier codes.

Said one or more identifier codes are bank identification codes. Said data features may include at least one of a country, state, city, province, district, and county. In one embodiment, said processor retrieving said rating may further comprise said processor calculating geographic and anti-money laundering risk ratings for a plurality of countries and identifying said risk data for said data features from said calculated geographic and anti-money laundering risk ratings. In another embodiment, said processor determining said risk rating for each of said one or more identifier codes may further comprise said processor determining said risk rating for each of said one or more identifier codes based on a nature of transactions occurring in said branch facilities. In yet another embodiment, said processor generating said risk rating data may further comprise said processor generating a heat map based on said risk rating for each of said one or more identifier codes. Said heat map may comprise a graphical representation that includes a plurality of colors corresponding to risk rating values. Said heat map may further comprise a geographical map including an overlay including said plurality of colors over locations associated with said one or more identifier codes based on said risk rating for each of said one or more identifier codes.

According to one embodiment, said computer program product comprises a computer readable storage medium having stored thereon program instructions executable by a processing device to cause said processing device to receive one or more identifier codes from a client device, wherein said one or more identifier codes correspond to branch facilities. Said computer program product further comprises program instructions executable by said processing device to cause said processing device to identify data features associated with said one or more identifier codes. Said computer program product further comprises program instructions executable by said processing device to cause said processing device to retrieve risk data for said data features. Said computer program product further comprises program instructions executable by said processing device to cause said processing device to determine a risk rating for each of said one or more identifier codes based on said risk data for said data features. Said computer program product further comprises program instructions executable by said processing device to cause said processing device to generate risk rating data based on said determined risk rating for each of said one or more identifier codes.

In one embodiment, said program instructions executable by said processing device to cause said processing device to generate said risk rating data may further comprise program instructions executable by said processing device to cause said processing device to generate a heat map based on said risk rating for each of said one or more identifier codes. Said heat map comprises a graphical representation that includes a plurality of colors corresponding to risk rating values. Said heat map may further comprise a geographical map including an overlay including said plurality of colors over locations associated with said one or more identifier codes based on said risk rating for each of said one or more identifier codes.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 depicts a logical block diagram of a computing system for analyzing anti-money laundering data features according to an embodiment of the present invention.

FIG. 4 depicts a flowchart of a method for analyzing anti-money laundering data features according to an embodiment of the present invention.

FIG. 5 depicts a flowchart of an exemplary software routine for calculating rating tier according to an embodiment of the present invention.

FIG. 6 depicts a flowchart of a method for assigning data to coded entities according to an embodiment of the present invention.

### DETAILED DESCRIPTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Exemplary methods, computing systems, and computer program products for analyzing anti-money laundering (AML) data features in accordance with the present invention are described with reference to the accompanying drawings. When a user changes a risk indicator score of a specific risk indicator or a weight variable within a geographic risk rating system, an embodiment of the present invention identifies which specific AML risk factors are affected by the change in certain countries. In response to a change in a risk indicator score within the geographic risk rating system, the system can determine the consequences of these changes. The specific risk indicator or weight variable may include a tag that links to an AML risk factor and an AML risk factor threshold value that, if exceeded by the change in the risk indicator score, triggers a response that the AML risk factor threshold has been exceeded. Additionally, the system may update a likelihood of an institution being exposed to a sanction based on the changes to the ratings system.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

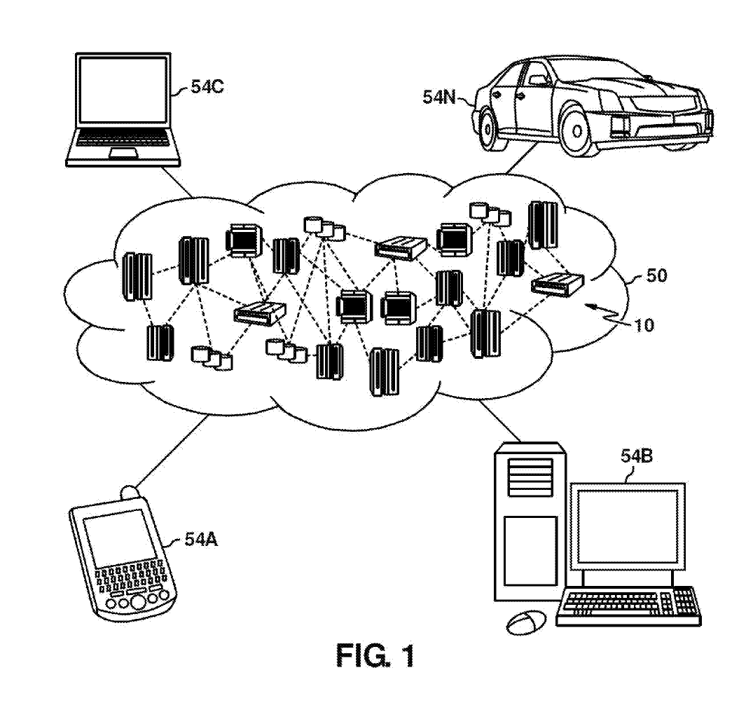

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

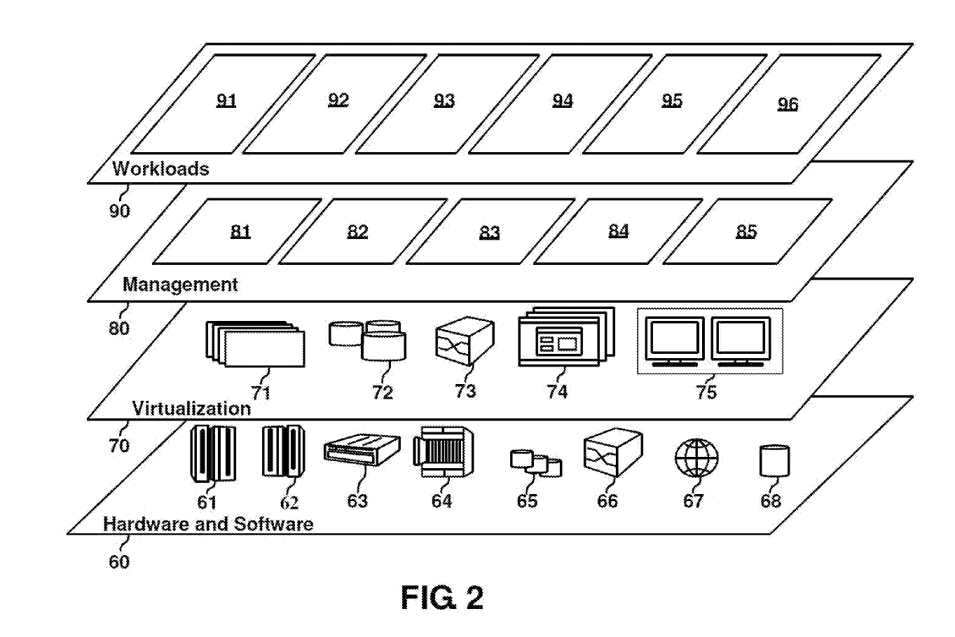

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and geographic risk processing 96.

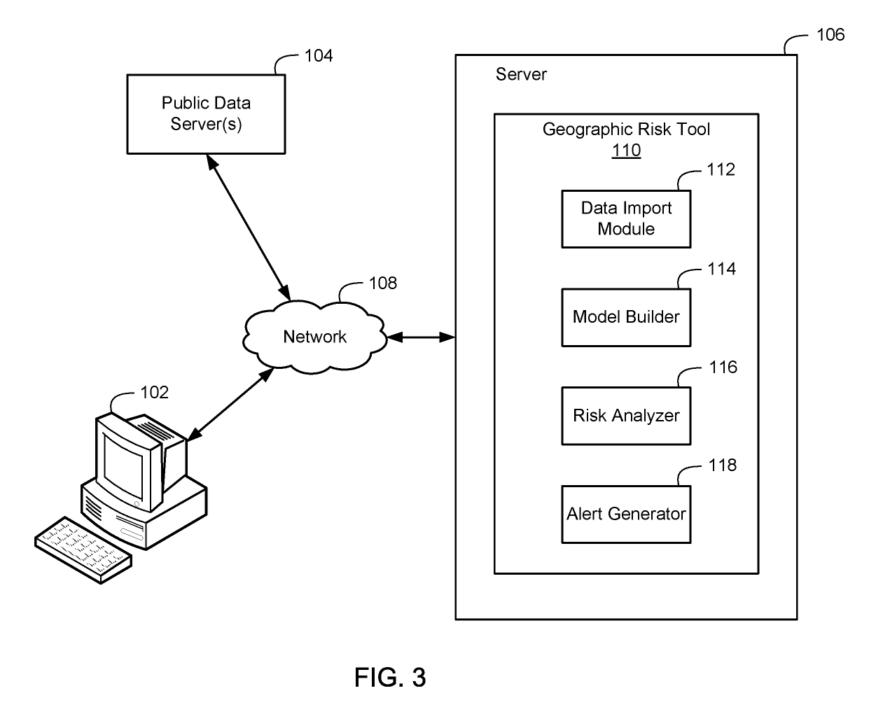

FIG. 3 presents a logical block diagram of a system for analyzing AML data features according to one embodiment of the present invention. The present invention is not limited to the arrangement of servers and other devices in the exemplary system illustrated in FIG. 3, but rather are for explanation. Data processing systems useful according to various embodiments of the present invention may include additional servers, routers, other devices, and peer-to-peer architectures, not shown in FIG. 3, as understood by those of skill in the art.

The system includes a client device 102 and public data server(s) 104 communicatively coupled to server 106 via a network 108. Client device 102 may comprise computing devices having a central processing unit and memory unit capable of connecting to a network. The client device 102 may also comprise a graphical user interface (GUI) or a browser application provided on a display (e.g., monitor screen, LCD or LED display, projector, etc.). A client device 102 may include or execute a variety of operating systems, such as personal computer operating systems (e.g., Windows, Mac OS or Linux, etc.), mobile operating systems (e.g., iOS, Android, or Windows Mobile, etc.), or the like. A client device 102 may also include or may execute a variety of possible applications, such as a client software application enabling communication with other devices, such as communicating one or more messages, such as via email, short message service (SMS), or multimedia message service (MMS).

The system further includes automated computing machinery comprising the server 106 useful in geographic risk processing according to embodiments of the present invention. The server includes at least one computer processor or “CPU” as well as random access memory (“RAM”) which is connected through a high-speed memory bus and bus adapter to the processor and to other components of the server. Stored in RAM, or a hard drive connected to the RAM, may be a geographic risk tool 110 including computer program instructions that, when executed, cause the computer to perform geographic risk assessment for institutional users. Geographic risk tool 110 may be used in transaction monitoring systems, “know your customer” programs, and enterprise-wide risk assessments. According to embodiments of the present invention, geographic risk tool 110 can analyze AML data features to derive risk factors and rate, for example, countries (or geographies), entities, or individuals, according to their risk of money laundering and terrorist financing based on the risk factors.

Geographic tool 110 includes data import module 112, model builder 114, risk analyzer 116, and alert generator 118. The model builder 114 may comprise, for example, an artificial intelligence unit trained using machine learning techniques such as, support vector machines, neural networks, clustering, decision tree learning, etc., to identify AML data features from data received from public data server(s) 104 via import module 112.

Public data server(s) 104 may comprise a computing device operable to provide access to, for example, files such as, documents, tables, charts, illustrations, photographs, etc., corresponding to AML regulation compliance, guidance and feedback related to AML and geographic risk from regulators and leading financial institutions. The data from public data server(s) 104 may comprise text including elements against which criteria of geographic risk may be measured or otherwise compared. The text may fulfill criteria (e.g., AML and/or terrorist financing data features) to meet in order to qualify as text that relates to various AML risk factors. The model builder 114 may be configured with data import module 112 to receive the data from public data server(s) 104 to build risk scoring models. The risk scoring models may contain AML risk factors including a plurality of risk indicators, within one or more categories, based on the AML data features. The risk indicators may be populated with scores received from client device 102, e.g., via a graphical user interface or file upload by a user. Model builder 114 is operable to add a tag to a risk indicator in a risk scoring model to link an AML risk factor to the risk indicator.

Risk analyzer 116 may receive a risk scoring model from model builder 114 and use the risk scoring model to calculate a risk score, rank, and/or rating tier of, for example, a country/state/city, entity, or individual of which an institution desires to conduct business with. Formulae for calculating risk score, rank, and/or rating tier may be predetermined based on priority and importance of certain risk indicators as dictated by a set of AML regulation compliance rules or data from the public data server(s) 104. For example, risk analyzer 116 may rate whether a country runs a high, medium, or low risk of money laundering and terrorist financing based on different categories of risk indicators. The outcome of such analyses may also depend on several other factors including the business nature, e.g., perspective, and transactions of an institution.

According to one embodiment, at least one identifier code, such as a bank identification code (BIC), may be provided from client device 102 to identify at least one data feature, such as a local branch facility location in one or more countries or geographic regions. For example, an institution may own and/or operate a plurality of branch facilities in a plurality of geographic locations. An identifier code may contain letters and numbers that identify a particular branch worldwide. Risk analyzer 116 may assess a risk rating for each local branch facility of the institution identifiable through their identifier codes based on risk data for data features, e.g., regions, associated with the local branch facilities (and optionally based on the nature of transactions occurring in the local branch facilities located within the regions). Other data features may include characteristics of a branch facility, such as type of business, number of clients, volume of business transactions, average size of each business transaction, date of establishment, etc.

Institutions may further customize calculations of the risk analyzer 116 specific to their business needs. Risk analyzer 116 may determine how these customizations can remain accurate within the context of AML regulation compliance. The risk analyzer 116 is operable to evaluate how compliance with such guidelines and regulations (and AML risk factors) are affected, for example, in certain countries by configuring or weighting certain risk indicators or risk factors. In response to a user changing a risk indicator score in a risk scoring model (through client device 102), the risk analyzer 116 can determine the consequences of these changes. According to one embodiment, when a user changes a score of one or more specific risk indicators or a weight variable of the risk indicators within a risk scoring model, risk analyzer 116 can identify which specific AML risk factors are affected by the change for certain countries. In this embodiment, the specific risk indicator(s) may include a tag that links to an AML risk factor and a threshold value that, if exceeded by the user's change in risk indicator score, triggers a response by alert generator 118 that the AML risk factor threshold has been exceeded. According to another embodiment, alert generator 118 may update a likelihood of an institution being exposed to a sanction based on the changes to the risk scoring models.

Stored in RAM also is an operating system. Operating systems useful for geographic risk processing according to embodiments of the present invention include UNIX™ Linux™ Microsoft Windows™ AIX™ IBM's i5/OS™ and others as will occur to those of skill in the art. Non-volatile computer memory also may be implemented for such as an optical disk drive, electrically erasable programmable read-only memory (so-called ‘EEPROM’ or ‘Flash’ memory), RAM drives, and so on, as will occur to those of skill in the art.

Network 108 may be any suitable type of network allowing transport of data communications across thereof. Network 108 may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices and servers may be encrypted using, for example, the Advanced Encryption Standard (AES) with a 128, 192, or 256-bit key size, or any other encryption standard known in the art.

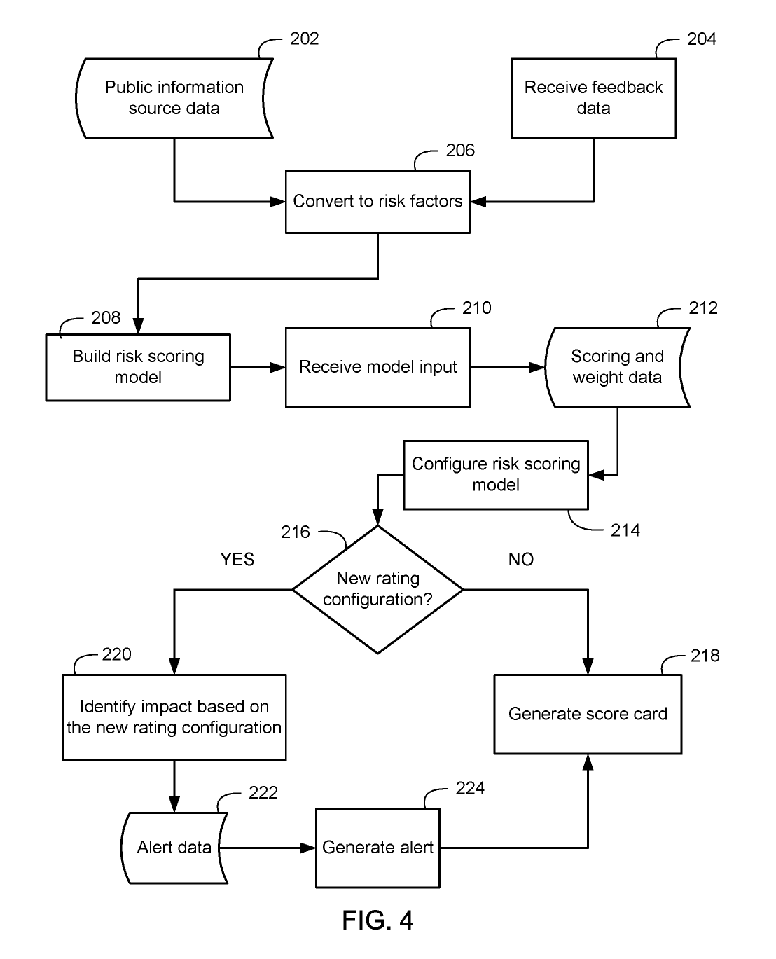

FIG. 4 illustrates a flowchart of a method for analyzing anti-money laundering data features according to an embodiment of the present invention. Public information source data 202 and feedback data (step 204) may be received by a data processing system and converted to risk factors, step 206. The public information source data 202 may include, for example, files such as, documents, tables, charts, illustrations, photographs, etc., corresponding to AML regulation compliance, guidance and feedback related to AML and geographic risk from regulators and leading financial institutions. The feedback data 204 may similarly include supplemental guidance or suggestions related to AML and geographic risk from subscribers or users of the data processing system. Converting the data to risk factors may include machine parsing AML data features from the public information source data and feedback data that correspond to AML regulation compliance, guidance and feedback related to AML and geographic risk. Machine parsing may include natural language processing may be used to extract and separate information pertaining to a variety of topics, genres, or subject matter from structured or unstructured data into logical segments. The logical segments may pertain to, for example, different subjects or different jurisdictions. NLP can be used to analyze text in combination with machine-learning to facilitate understanding of the public information source data and feedback data by a computer. The AML data features may then be converted into risk factors for building a risk scoring model. The risk factors may indicate a potential for conducting illicit activities in connection with, for example, countries, entities, or individuals.

A risk scoring model is built from the risk factors, step 208. The risk scoring model may comprise a weighted scoring structure that uses the risk factors to provide calculations for a risk score, rank, and/or rating tier of a country/state/city, entity, or individual based on a cumulative weight of risk factors indicative of money laundering and terrorist financing. Risk factors may include risk indicators that are categorized and assigned particular scores and weights according to degree of risk and importance as determined based on rules, laws, or regulations (e.g., from the public information source data 202). The risk factors may be ranked and, based on the rank, each of the risk factors can be assigned to a rating tier (e.g., high, medium, or low risk). Each of the rating tiers represents a level of risk that illicit activities may be conducted in connection with a particular country/state/city, entity, or individual, for example. The risk factors may include risk indicators that can be categorized under sections such as sanctions and special measures, terrorism and drugs, offshore/tax haven, Financial Crimes Enforcement Network—The Financial Action Task Force (FinCEN FATF) compliance factors, World Bank Worldwide Governance Indicators, corruption indicators, and International Narcotics Control Strategy Reports (INCSR) Major Money Laundering countries and criteria. According to one embodiment, the risk scoring model may be built according to different regulatory body perspectives on AML risk. For example, a U.S. perspective risk scoring model may assign heavy weights to risk factors derived from U.S. government sanctions programs (e.g., OFAC and Sec. 311) to reflect the importance that U.S. regulators place on compliance with these programs. Whereas a non-U.S. perspective risk scoring model may assign slightly lower weights to U.S. sanctions programs relative to their international counterparts (e.g., European Union and United Nations).

Input for the risk scoring model is received, step 210. A user interface may be provided to receive input for populating and editing the risk scoring model. The data processing system may receive scoring and weight data 212 from the input. The scoring and weight data 212 may include values, e.g., 1-10, yes/no, etc., for each risk indicator that can be used to calculate a risk score, ranking, and/or rating tier. Scoring and weight data 212 may further include values for assigning customized scores and weights to the risk indicators. Scores and weights of risk indicators in the risk scoring model may be configured at default values (e.g., for given countries, entities, or individuals) if weights are not provided or changed from the default values.

The risk scoring model is configured with the scoring and weight data, step 214. Values from the scoring and weight data 212 may be assigned to the risk factors. A determination is made whether there is a new rating configuration of the risk scoring model, step 216. A new rating configuration may include a change in scoring or weight to the risk scoring model provided by the scoring and weight data 212. If there are no changes to the rating configuration of the risk scoring model, a score card is generated, step 218. Generating the score card may include executing a plurality of routines for calculating risk score, rank, and/or rating tier using the risk scoring model. The calculated risk score, rank, and/or rating tier may be included in instructions for generating a graphical presentation to a user along with the risk indicators, scores, and weightings that were used.

If a determination is made that there is a new rating configuration at step 216, an impact based on the new rating configuration is identified, step 220. When a user changes a score of a specific risk indicator or a weight variable, the data processing system is able to identify which specific risk factors are affected by the change, for example, in certain countries. The specific risk indicator or weight variable may include a tag that links to a risk factor and a risk factor threshold value that, if exceeded by the change in the risk indicator score, triggers a response that the risk factor threshold has been exceeded. In response to a change in a risk indicator score that exceeds the risk factor threshold, the system can determine the consequences of these changes and create alert data 222. According to another embodiment, the system may update a likelihood of an institution being exposed to a sanction based on the changes.

An alert is generated using the alert data, step 224. The alert data 222 may include an aggregate of risk factors that exceed their thresholds. Accordingly, generating the alert may include graphically presenting an indicator for each of the risk factors in the alert data 222. A score card may then be generated using the configured risk scoring model, step 218.

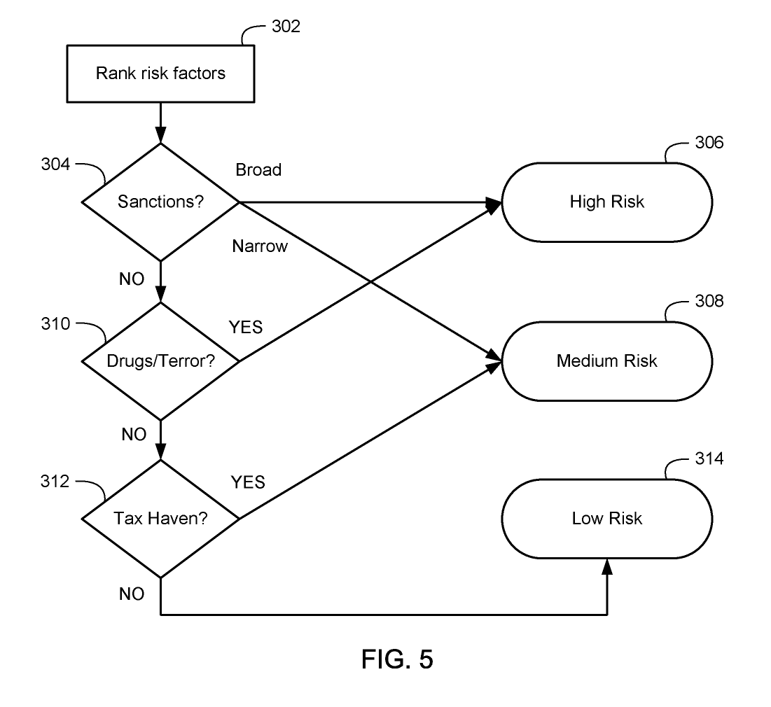

FIG. 5 illustrates a flowchart of an exemplary software routine for calculating rating tier according to an embodiment of the present invention. Risk factors are ranked in order of importance, step 302. For example, in the illustrated embodiment, whether a particular country has had sanctions imposed may be more important than whether a particular country has not criminalized money laundering beyond narcotics violations. Based on the rank of each of the risk factors, the risk factors may be assigned to one of a number of rating tiers. Each rating tier may represent a level of risk that illicit activities could be conducted in connection with, for example, a country/state/city, entity, or individual.

A determination is made whether a given country has been sanctioned and if so, are the sanctions broad or narrow, step 304. An imposition of broad sanctions results in a high-risk tier rating, step 306, while an imposition of narrow sanctions results in a medium risk tier rating, step 308. If there are no sanctions, the method may proceed to determine the country's an association with drugs and terrorism, step 310. If the country is negatively partial to drugs and terrorism, a high-risk tier rating, step 306, may be given. Otherwise, the method proceeds to determine whether the country is a tax haven, step 312. If the country is indeed a tax haven, it may be assigned a medium risk tier rating, step 308. Accordingly, the country may be assigned a low risk tier rating, step 314, if it does not have any of the risk factors.

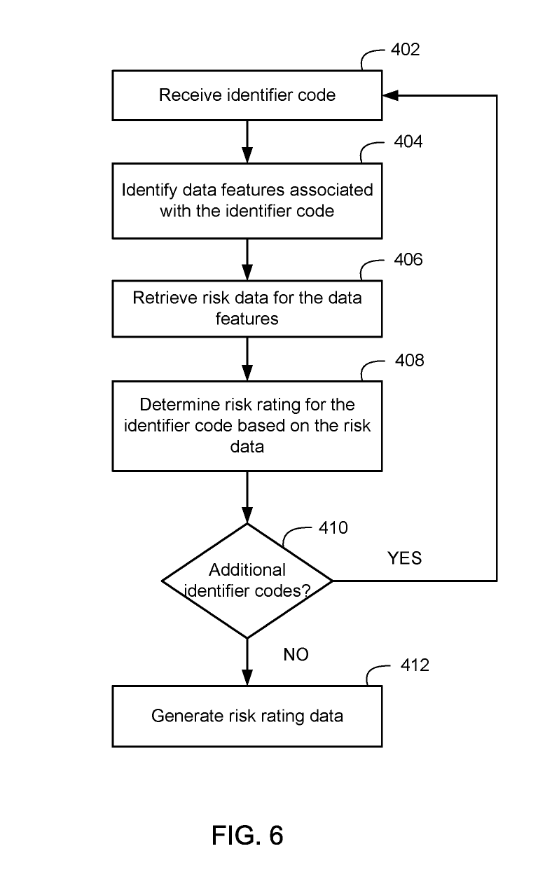

FIG. 6 presents a flowchart of a method for assigning data to coded entities according to an embodiment of the present invention. An identifier code is received, step 402. The identifier code may be received via a graphical user interface on a client device or via a file export, such as a spreadsheet of codes. The identifier code may be a BIC that identifies a particular branch facility of an institution that the institution desires to assess for a risk rating (e.g., based on a combination of factors, such as geographic, AML, etc.).

Data features associated with the one or more identifier codes are identified, step 404. The data features may include a region associated with the identifier code. The region may be a country, state, city, province, district, county, etc. of which the branch facility is physically located. The data features may be identified by accessing and searching a database or registry of codes for the identifier code to retrieve details of the branch facility including, for example, the name of the institution/branch, branch facility country, city of the branch facility, and address of the branch facility. Other data features that may be identified include characteristics of a branch facility, such as type of business, number of clients, volume of business transactions, average size of each business transaction, date of establishment, etc.

Risk data for the identified data features is retrieved, step 406. For example, a risk scoring model may be used by a risk rating system to calculate geographic risk and AML risk ratings for a plurality of countries. Risk data for the data features, such as a region, may be retrieved from the risk rating system for the calculated geographic risk and/or AML risk ratings pertaining to the region. A risk rating is determined for the identifier code based on the risk data for the data features, step 408. As such, a branch facility associated with the identifier code may be assigned a risk rating based on the rating data for the data features, e.g., the region. Additionally, the risk rating for the identifier code may be determined based on the nature of transactions occurring in the branch facility located within the region. The risk rating may be a numerical value, such as a value between 1-10 where a value of ‘1’ may indicate low risk and a value of ‘10’ may indicate high risk. Alternatively, the risk rating may be based on a relative scale, such as low risk, medium, or high risk.

A determination is made whether there are any additional identifier codes, step 410. The branch may be one of many branches that the institution owns or operates in one or more geographic locations. As such, the method may determine a risk rating for each branch of the institution identifiable through their identifier codes. The method may return to step 402 for each identifier code as provided by the institution. Otherwise, if there are no additional identifier codes, the method proceeds to generate risk rating data based on the determined risk rating(s) for one or more identifier codes, step 412.

In one embodiment, generating risk rating data may include generating a heat map indicative of the risk ratings of the identifier codes. The heat map may be a graphical representation that employs a plurality of colors to signify the value of risk ratings (e.g., high, medium, or low risk) at various points in a spectrum. The heat map may comprise a guide for the user to identify regions with higher risks. In one embodiment, the heat map may include a geographical map from GIS software that is overlaid (e.g., over locations associated with the one or more identifier codes) with coloring based on risk rating over locations associated with the identifier codes.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 1 through 6 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, for assigning data to coded entities, the method comprising:
receiving, by the data processing system, one or more identifier codes from a client device, wherein the one or more identifier codes correspond to branch facilities;
identifying, by the data processing system, data features associated with the one or more identifier codes by accessing a registry;
retrieving, by the data processing system, risk data for the data features;
determining, by the data processing system, a risk rating for each of the one or more identifier codes based on the risk data for the data features; and
generating, by the data processing system, risk rating data based on the determined risk rating for each of the one or more identifier codes.

2. The method of claim 1 wherein the one or more identifier codes are bank identification codes.

3. The method of claim 1 wherein the data features include at least one of a country, state, city, province, district, and county.

4. The method of claim 1 wherein retrieving the rating further comprises:
calculating, by the data processing system, geographic and anti-money laundering risk ratings for a plurality of countries; and
identifying, by the data processing system, the risk data for the data features from the calculated geographic and anti-money laundering risk ratings.

5. The method of claim 1 wherein determining the risk rating for each of the one or more identifier codes further comprises determining, by the data processing system, the risk rating for each of the one or more identifier codes based on a nature of transactions occurring in the branch facilities.

6. The method of claim 1 wherein generating the risk rating data further comprises generating, by the data processing system, a heat map based on the risk rating for each of the one or more identifier codes.

7. The method of claim 6 wherein the heat map comprises a graphical representation that includes a plurality of colors corresponding to risk rating values.

8. The method of claim 7 wherein the heat map comprises a geographical map including an overlay including the plurality of colors over locations associated with the one or more identifier codes based on the risk rating for each of the one or more identifier codes.

9. A computing system for assigning data to coded entities, the computing system comprising a computer processor and a computer memory operatively coupled to the computer processor, the computer memory having disposed within it computer program instructions that, when executed by the processor, cause the computing system to carry out the steps of:
receiving one or more identifier codes from a client device, wherein the one or more identifier codes correspond to branch facilities;
identifying data features associated with the one or more identifier codes by accessing a registry;
retrieving risk data for the data features;
determining a risk rating for each of the one or more identifier codes based on the risk data for the data features; and
generating risk rating data based on the determined risk rating for each of the one or more identifier codes.

10. The computing system of claim 9 wherein the one or more identifier codes are bank identification codes.

11. The computing system of claim 9 wherein the data features include at least one of a country, state, city, province, district, and county.

12. The computing system of claim 9 wherein the processor retrieving the rating further comprises the processor:
calculating geographic and anti-money laundering risk ratings for a plurality of countries; and
retrieving the risk data for the data features from the calculated geographic and anti-money laundering risk ratings.

13. The computing system of claim 9 wherein the processor determining the risk rating for each of the one or more identifier codes further comprises the processor determining the risk rating for each of the one or more identifier codes based on a nature of transactions occurring in the branch facilities.

14. The computing system of claim 9 wherein the processor generating the risk rating data further comprises the processor generating a heat map based on the risk rating for each of the one or more identifier codes.

15. The computing system of claim 14 wherein the heat map comprises a graphical representation that includes a plurality of colors corresponding to risk rating values.

16. The computing system of claim 15 wherein the heat map comprises a geographical map including an overlay including the plurality of colors over locations associated with the one or more identifier codes based on the risk rating for each of the one or more identifier codes.

17. A computer program product for assigning data to coded entities, the computer program product comprising:
a computer readable storage medium having stored thereon:
program instructions executable by a processing device to cause the processing device to receive one or more identifier codes from a client device, wherein the one or more identifier codes correspond to branch facilities;
program instructions executable by the processing device to cause the processing device to identify data features associated with the one or more identifier codes by accessing a registry;
program instructions executable by the processing device to cause the processing device to retrieve risk data for the data features;
program instructions executable by the processing device to cause the processing device to determine a risk rating for each of the one or more identifier codes based on the risk data for the data features; and
program instructions executable by the processing device to cause the processing device to generate risk rating data based on the determined risk rating for each of the one or more identifier codes.

18. The computer program product of claim 17 wherein the program instructions executable by the processing device to cause the processing device to generate the risk rating data further comprises program instructions executable by the processing device to cause the processing device to generate a heat map based on the risk rating for each of the one or more identifier codes.

19. The computer program product of claim 18 wherein the heat map comprises a graphical representation that includes a plurality of colors corresponding to risk rating values.

20. The computer program product of claim 19 wherein the heat map comprises a geographical map including an overlay including the plurality of colors over locations associated with the one or more identifier codes based on the risk rating for each of the one or more identifier codes.
